(19) United States
(12) Patent Application Publication
(10) Pub. No.: US 2014/0078004 A1
(43) Pub. Date: Mar. 20, 2014

(54) ANTENNA SYSTEM

(71) Applicants: Morten Christensen, Aalborg (DK); Ole Jagielski, Frederikshavn (DK); Simon Svendsen, Aalborg (DK)

(72) Inventors: Morten Christensen, Aalborg (DK); Ole Jagielski, Frederikshavn (DK); Simon Svendsen, Aalborg (DK)

(73) Assignee: Molex Incorporated, Lisle, IL (US)

(21) Appl. No.: 14/118,252

(22) PCT Filed: May 21, 2012
(86) PCT No.: PCT/US2012/038839

§ 371 Date: Nov. 18, 2013

Related U.S. Application Data
(60) Provisional application No. 61/487,777, filed on May 19, 2011.

(51) Int. Cl. H01Q 9/04

(52) U.S. Cl. CPC H01Q 9/04
USPC 343/700 MS

(57) ABSTRACT

An antenna is disclosed where a third resonator is added to the resonating structure. Impedance bandwidth improvements can be obtained for both high and low bands, with only a small increase of the antenna volume. The low band bandwidth can be further enhanced by active switching of the low band feed.

### RELATED APPLICATIONS

This Application claims priority to U.S. Provisional Application No. 61/487,777, filed May 19, 2012, which is incorporated herein by reference in its entirety.

### FIELD OF THE INVENTION

The present invention relates to field of antennas, more specifically to the field of antennas suitable for use in mobile devices.

### DESCRIPTION OF RELATED ART

One known antenna concept is referred to as a Dual Fed Dual Inverted L Antenna (DF-DILA). The DF-DILA antenna concept is implemented in the Motorola ZN5 mobile phone. A simple reference model of the DF-DILA concept is developed to illustrate its principles and is illustrated in FIG. 1. The general dimensions of this model are: printed wiring board 15 (PWB)=40×100 mm, cutback under the element is 40×3 mm and the element is 5 mm above the PWB. The element 20 includes a first arm 22 and a second arm 24. A first feed 16 is configured to provide an low band feed and a second feed 18 is configured to provide a high band feed. The unmatched impedance of the standard DF-DILA is shown in FIG. 2, which includes high band impedance 40 (which includes a resonance) and low band impedance 50. This is obtained by combining the two feeding connections, which then acts as a single feed.

It is seen from FIG. 2 that the element itself only has 1 resonance, which can be tuned for high band operation, like GSM1800, GSM1800 and/or UMTS Band I. The resonance is created due to the different length of the 2 arms, seen from the feeding. The element acts as a coupler for the low band operation, like GSM 850 and/or GSM 900. The basic idea is to move both impedance areas of interest into the same location in the smith chart, which is done by splitting the feed into two, whereby the low band is fed through a series inductor and high band through a series capacitor. The resulting impedance 35 is shown in FIG. 3, which includes high band impedance 40′ and low band impedance 50′. Both bands can now be transformed into the desired SWR circle of 3 by a shunt inductor and a shunt capacitor, as shown in FIGS. 4A (which shows impedance of Low band (GSM850 and GSM 900)) and 4B (which shows Impedance of High band (GSM 1800, GSM 1900 and UMTS Band I)) so as to provide suitable bandwidth. As can be appreciated from FIGS. 4A and 4B, the DF-DILA in this configuration can cover 3 bands, one low band and 2 high bands. The typical matching circuit for the DF-DILA concept is shown in FIG. 5.

While this antenna design has proven acceptable, further improvements in lower frequency and higher frequency bandwidth would be beneficial. However, conventional techniques for providing these improvements would increase the volume of the antenna undesirably. Therefore, certain individuals would appreciate an improved antenna design that provided the benefits of increased antenna volume without the need for what would be an expected amount of increase in the antenna volume.

### BRIEF SUMMARY

An antenna is disclosed that is based on the Dual Fed Dual Inverted L Antenna (DF-DILA) structure. A third resonator is added to the resonating structure and this results in a design that increases the antenna volume for low band operation (thus increasing the low band bandwidth) and also provides an additional resonance for high band operation (thus increasing the high-band bandwidth). In certain embodiments, impedance bandwidth improvements can be obtained for both high and low bands, with only a small increase of the antenna volume. The low band bandwidth can be further enhanced by active switching of the low band feed. Thus an improved performing antenna can be provided in a manner that does not require a substantial increase in antenna volume.

### BRIEF DESCRIPTION OF THE DRAWINGS

The present invention is illustrated by way of example and not limited in the accompanying figures in which like reference numerals indicate similar elements and in which:

FIG. 1 illustrates an embodiment of a prior art antenna system.

FIG. 2 illustrates an impedance plot of the antenna system depicted in FIG. 1.

FIG. 3 illustrates an impedance plot of the antenna system depicted in FIG. 1 with a split feed.

FIG. 4A illustrates an impedance plot of the low band of the antenna system in FIG. 1 with a matching network.

FIG. 4B illustrates an impedance plot of the high band of the antenna system in FIG. 1 with a matching network.

FIG. 5 illustrates a schematic diagram of matching network for the antenna system depicted in FIG. 1.

FIG. 6 illustrates a perspective view of an embodiment of an antenna system.

FIG. 7 illustrates an impedance plot of the antenna system depicted in FIG. 6.

FIG. 8 illustrates an impedance plot of the antenna system depicted in FIG. 6 with a split feed.

FIG. 9A illustrates an impedance plot of a high band response of the antenna system depicted in FIG. 6 with a matching network.

FIG. 9B illustrates an impedance plot of a low band response of the antenna system depicted in FIG. 6 with a matching network.

FIG. 10 illustrates a chart of frequency response comparing the system of FIG. 1 with the system of FIG. 6.

FIG. 11 a schematic diagram of matching network with band for the antenna system depicted in FIG. 6 with low band switching.

FIG. 12 illustrates low band frequency response of the antenna of FIG. 6 with low band switching.

FIG. 13 illustrates a voltage plot across the diodes used to provide the low band switching.

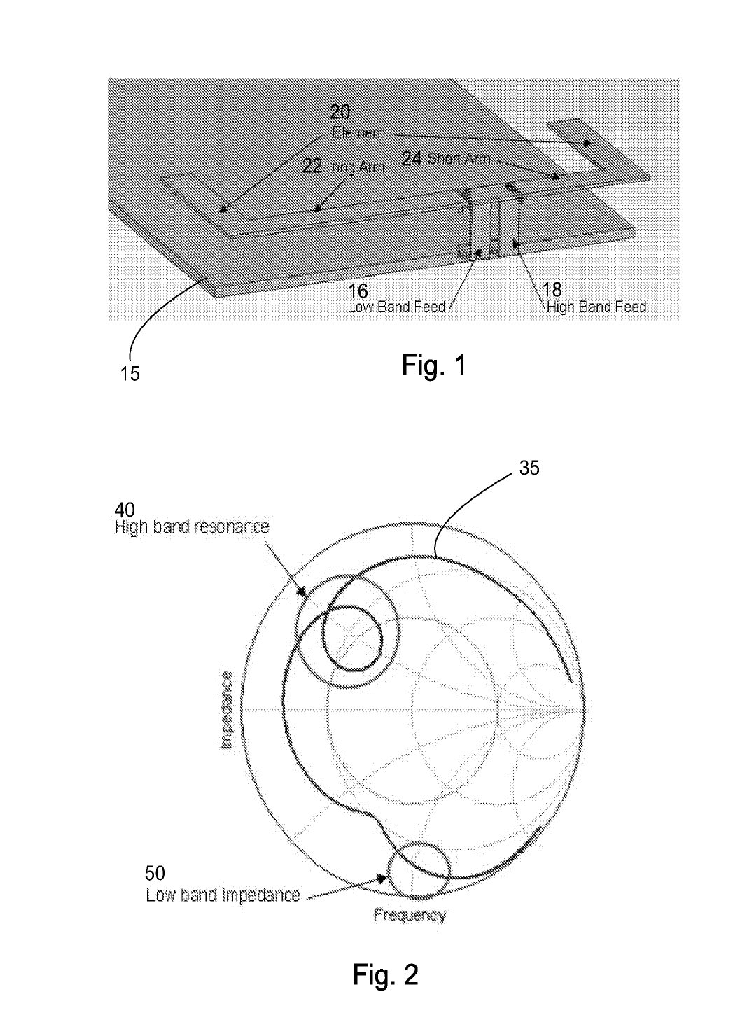

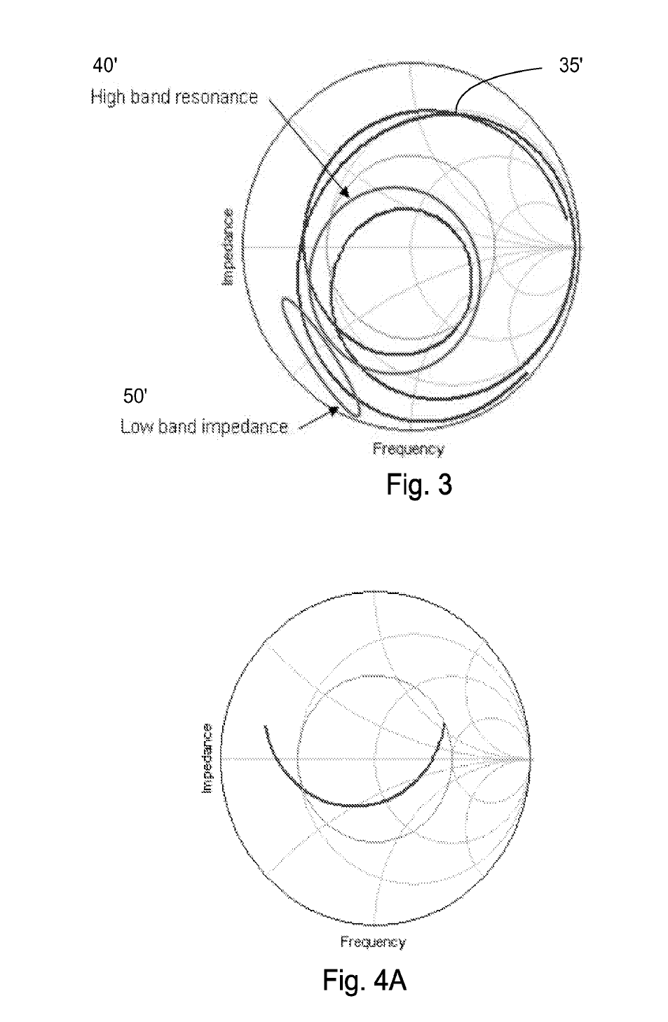

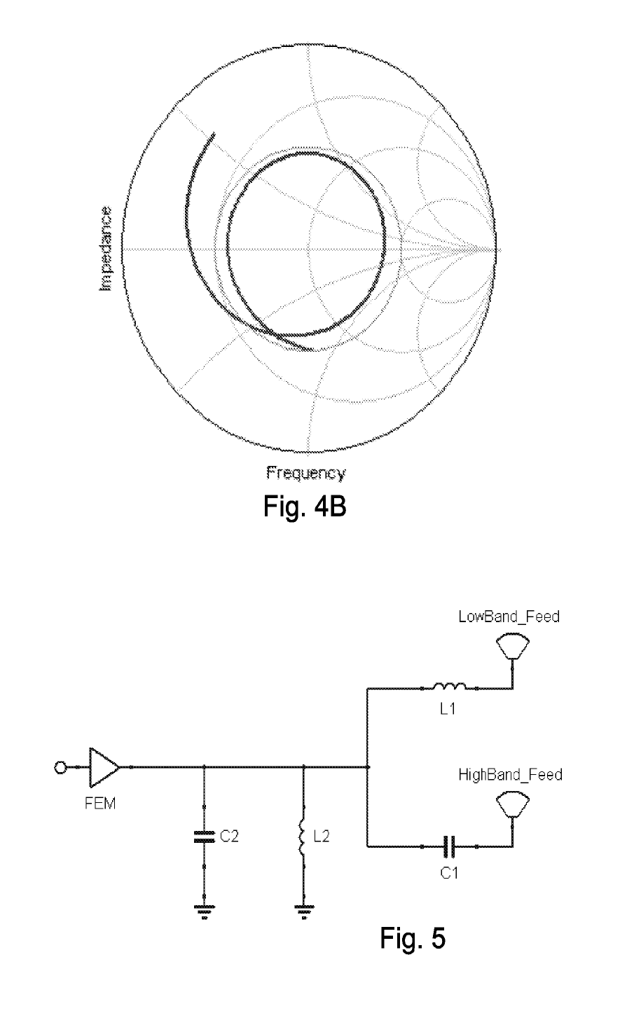

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

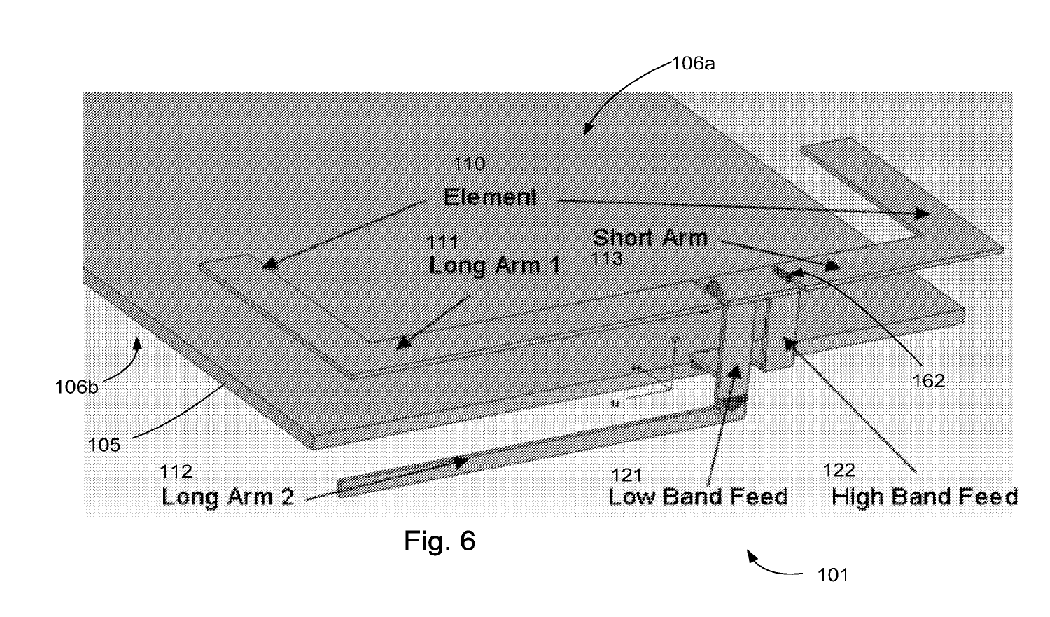

As can be appreciated from FIG. 6, an antenna system 101 that can be referred to as providing a Dual Fed Triple Inverted L Antenna (DF-TILA) is disclosed. The antenna system includes a circuit board 105, which may be a conventional printed circuit board or any desirable structure of comparable design (for example, a LDS structure with traces positioned on the structure). The circuit board 105 includes a first side 106a and a second side 106b. Positioned about the circuit board 106 are elements 110 that are configured to resonate. As depicted, this includes a first arm 111, a second arm 112 and a third arm 113. As can be appreciated, therefore, one difference between the DF-TILA system and a DF-DILA system is the second element attached to the low band feed. It has been determined that it is beneficial if the second arm 112 is placed on the opposite site of the circuit board 105 compared to the first arm 111. This will reduce the coupling between the first arm 111 and the second arm 112, making the tuning of the antenna easier. Secondly, having the second arm 112 on the opposite site will also increase the impedance bandwidth of the low band resonance.

The unmatched impedance plot shows that the low impedance and high band resonance 1 are located more or less at the same positions in the smith chart as for the standard DF-DILA. A second high band resonance is created due the different length of the short arm and long arm 2, as can be appreciated from FIG. 6.

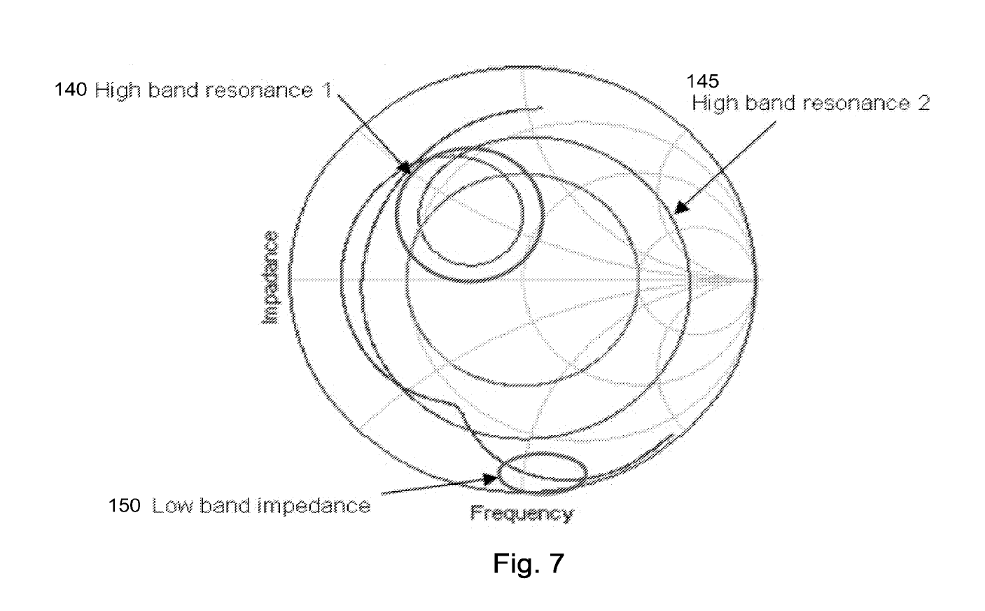

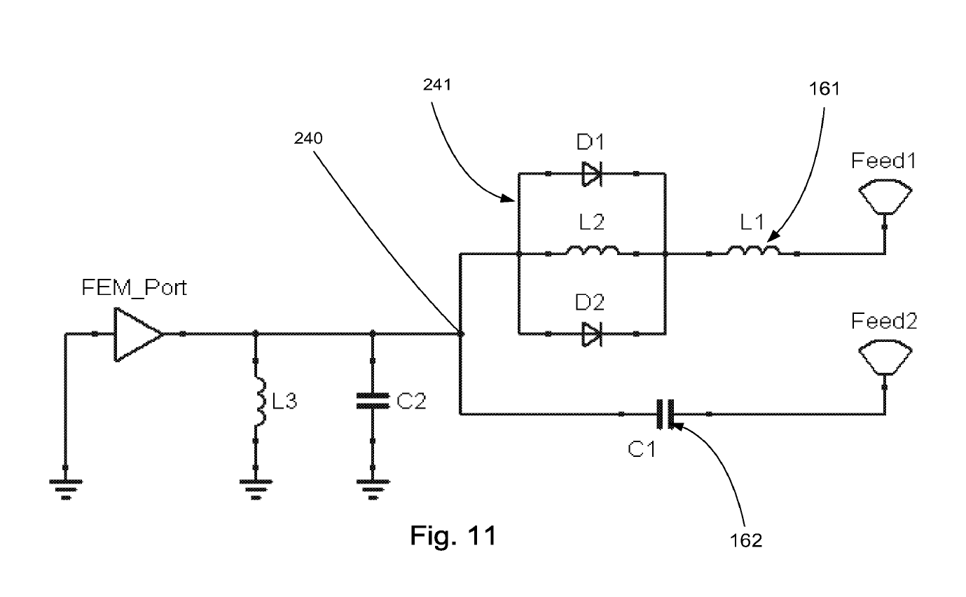

One would not expect, based on FIG. 6, that this concept will improve the bandwidth at both the low band resonance and the high band resonance. However, it has been determined that by splitting the feed at an input point 240 (see FIG. 11) into 2 feeds and adding one of a series capacitor and an inductor to the two different feeds the 2 high band resonances curl together (see FIG. 7), which provides an improved impedance bandwidth (e.g., a greater frequency range within a SWR circle of 3). Thus, a first feed 121 is provided directly to the first and second arms 111/112 and a second feed 122 is provided to the third arm 113. In series with the first feed 121 is an inductor 161 (L1) and in series with the second feed 122 is a capacitor 162.

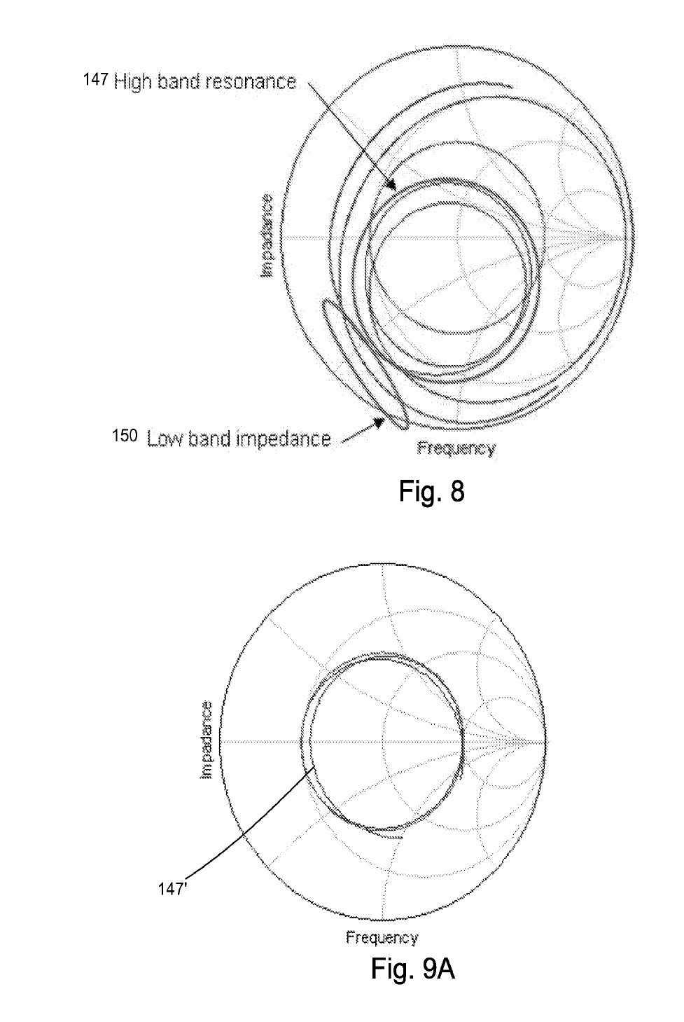

More specifically, as can be seen from FIG. 7, the high band impedance consists of a first resonance 140 and a second resonance 145, instead of the one resonance provided by the standard DF-DILA. Thus, somewhat surprisingly, the addition of the second arm 112, which can be connected to the third arm 113 via the common node 240, causes the second resonance 145 and increases the impedance bandwidth of the high band. The low band impedance 150 is also affected by the second long arm, since this is connected directly to the low band feed 121 and acts as part of the low band element, increasing the effective antenna volume and thereby the impedance bandwidth. The impedance plot with a matching circuit is shown in FIG. 8 and the same matching circuit as is used with the standard DF-DILA can be used.

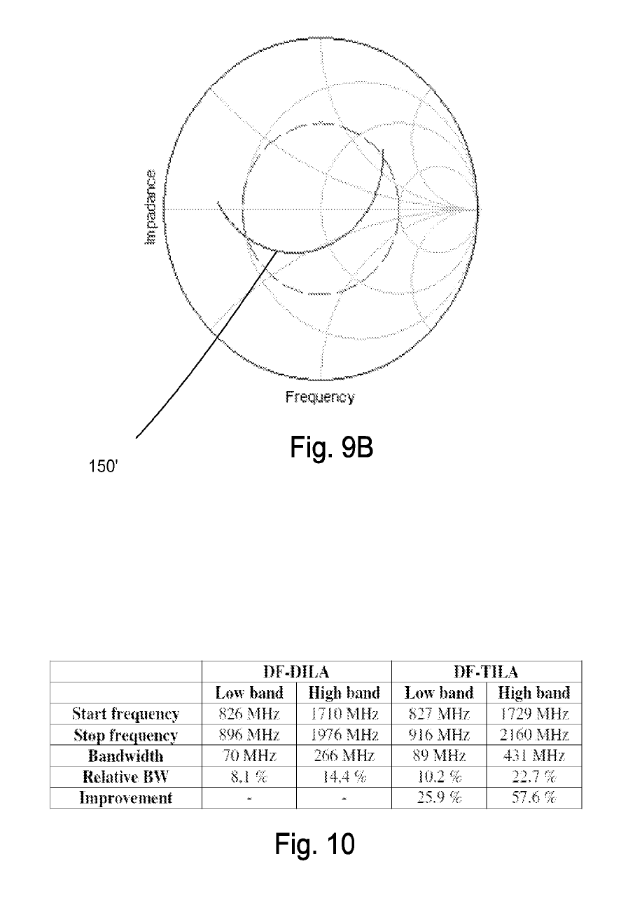

Consequentially, adding a second arm 112 increases the impedance bandwidth and this concept can now cover four bands, three high bands (as shown in FIG. 9A) and one low band (as shown in FIG. 9B). The results for the two concepts are compared in the table provided in FIG. 10. As can be appreciated, a substantial improvement is provided for both the low band and the high band. For example, the high band can readily provide a bandwidth of greater than 350 MHz and in preferred embodiments can provide a bandwidth of greater than 400 MHz. The low band can be configured to provide greater than 80 MHz of bandwidth. In addition, full penta band impedance bandwidth can be achieved by switching the low band as described below.

The low band switching is implemented by changing the value of the inductor L1 and thereby the resonance frequency of the low band resonance. Changing the value of L1 has very little influence on the high band resonance, so the high band performance can be considered to be independent of the low band switch. It has been determined that the impedance of the high band resonance should be optimized for the off state in order to reduce the on time of the diodes and thereby reduce the overall current consumption.

The switch can be implemented as a parallel combination of an inductor L2 and one or more diodes, as shown there being 2 PHEMT type diodes D1 and D2. The parallel switching circuit 241 is placed in series with inductor 161, as shown in FIG. 11. The number of diodes can vary, depending on, for example, the Q of the antenna and required antenna efficiency.

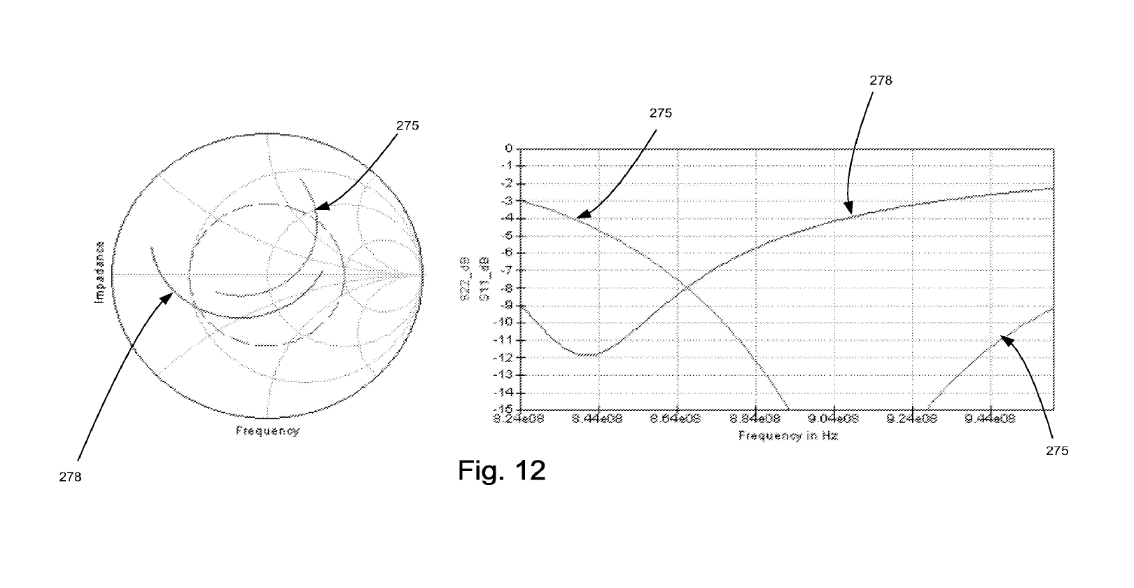

The 2 PHEMT type diodes, in parallel, are modeled with a Rₒₙ of 0.5Ω and a C_{off} of 2.4 pf. The combined inductance of the parallel switching circuit can thus be changed, depending on the state of the PHEMT type diodes. The complex impedances for the 2 switching states are shown in FIG. 12, which illustrates low band resonance at an on state (plot 275) and an off state (plot 278) and shows that the 2 low bands (GSM850 and GSM900) are now covered as the frequency response is suitable (e.g., within a SWR circle of 3) between about 820 MHz and 950 MHz (e.g., over 120 MHz of bandwidth).

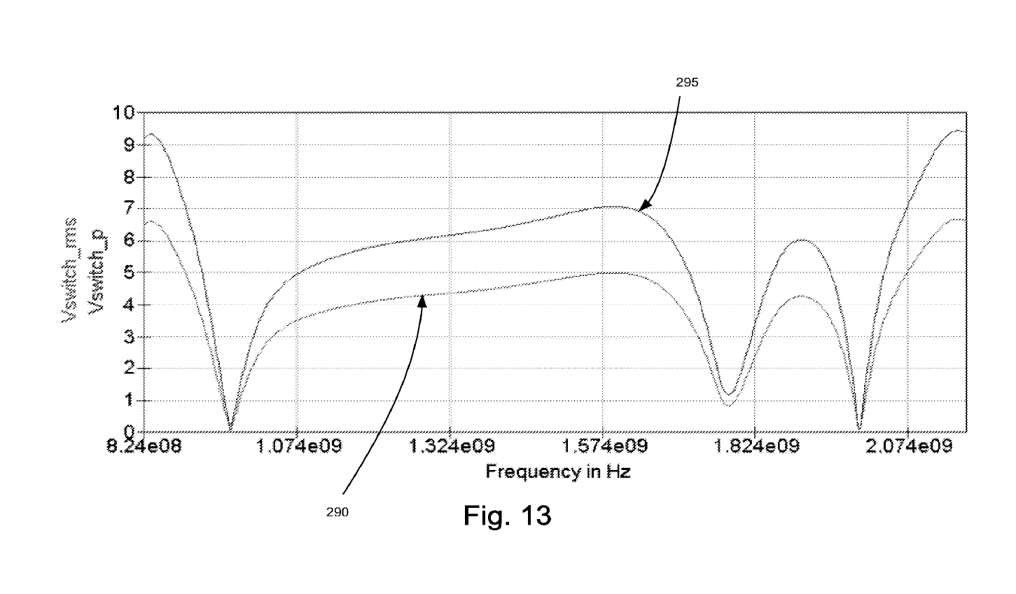

It is beneficial to ensure that the parallel resonance of the switching circuit is not overlapping with any on the desired frequency ranges of the communication systems, since this most likely will introduce an undesired loss. The maximum control voltage for the used PHEMT diodes is −12 V, which in theory means the that the maximum RF voltage across the diodes, in off stage, should be less than this, in order to avoid self biasing and/or operation in the unlinear region. The simulated peak voltage 295 and rms voltage 290 across the PHEMT diodes in an off state is shown in FIG. 13 for an AC input level of 35 dBm. The maximum rms voltage swing over the desired frequency range is approximately 7V with a 35 dBm input AC signal. This is well below the maximum diode control voltage of −12 V. Thus the depicted antenna system provides desirable performance in a compact package.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. An antenna system, comprising:
a circuit board having a first and second side;
a first arm having a first length, the first arm positioned on the first side;
a second arm having a second length that is less than the first length, the second arm positioned on the second side;
a third arm having a third length less than the second length, the third arm positioned on the first side;
a feed configured to provide an input to the first, second and third arms;
a capacitor positioned in series between the feed and the third arm; and
an inductor positioned in series between the feed and the first and second arms, wherein the antenna system is configured to provide a high band bandwidth of at least 350 MHz and a low band bandwidth of at least 80 MHz.

2. The antenna system of claim 1, wherein the high band bandwidth is at least 400 Mhz.

3. The antenna system of claim 2, wherein the inductor is configured to switch between a first value and a second value, the switching enabling the low band bandwidth to be greater than 100 MHz.

4. The antenna system of claim 3, wherein the switching enables the low band bandwidth to be greater than 120 MHz.

5. The antenna system of claim 4, wherein the switching is provided by a parallel switching circuit positioned in series with the inductor between the feed and the first and second arm.

6. The antenna system of claim 5, wherein the parallel switching circuit includes at least two diodes and a second inductor in parallel.
